(19) United States
(12) Patent Application Publication
(10) Pub. No.: US 2021/0248573 A1
(43) Pub. Date: Aug. 12, 2021

(54) ELECTRONIC DEVICE AND METHOD FOR CONTROLLING A FUNCTION OF AN ELECTRONIC DEVICE

(71) Applicant: Infineon Technologies AG, Neubiberg (DE)

(72) Inventor: Thomas POEPPELMANN, Munich (DE)

(21) Appl. No.: 17/163,627

(22) Filed: Feb. 1, 2021

(30) Foreign Application Priority Data
Feb. 7, 2020 (DE) 10 2020 103 159.9

(51) Int. Cl. G06Q 20/06; G06Q 20/40; H04L 9/32; H04L 9/08

(52) U.S. Cl. CPC G06Q 20/0655; G06Q 20/401; H04L 9/3236; G06Q 2220/00; H04L 2209/38; H04L 2209/56; H04L 9/0825

(57) ABSTRACT

An electronic device may include a memory configured to store a cryptographic blockchain address, an input configured to receive at least parts of a blockchain block a verification circuit configured to verify whether the blockchain block includes a transaction with a predetermined property which is addressed to the blockchain address and a controller configured to enable a function of the electronic device if the verification circuit has verified that the blockchain block includes a transaction with the predetermined property which is addressed to the blockchain address.

### CROSS-REFERENCE TO RELATED APPLICATION

This non-provisional application claims priority to German application No. 10 2020 103 159.9 filed on Feb. 7, 2020, the entire contents of which are incorporated herein by reference.

### TECHNICAL FIELD

The present disclosure relates to electronic devices and methods for controlling a function of an electronic device.

### BACKGROUND

Counterfeiting is a major issue in consumer markets with consumables. There is a high risk professional companies create clones of an authentication device that act the same way as the original authentication device would. Another issue in this domain is that companies may have to allow recycling by third parties, e.g. refilling of printer cartridges. This may be adversarial to the business model of the original manufacturer. Thus, approaches may be desirable that allow a recycler to recycle a consumable (e.g. a cartridge) without help of the original manufacturer while still providing the original manufacturer with a certain control over the recycling, e.g. to allow the original manufacturer to get a monetary benefit from the recycler.

More generally, in some cases it may be beneficial to allow an entity to enable additional functions of a device (e.g. a microcontroller) or to set certain parameters later on, when a device is being used in the field. However, the required license or permission management can be problematic, e.g., if the manufacturer of the device goes out of business or discontinues the issuing of licenses. Therefore, approaches are desirable which allow the efficient control of a function of an electronic device.

### BRIEF SUMMARY

According to various embodiments, an electronic device is provided including a memory configured to store a cryptographic blockchain address, an input configured to receive at least parts of a blockchain block, a verification circuit configured to verify whether the blockchain block includes a transaction with a predetermined property which is addressed to the blockchain address and a controller configured to enable a function of the electronic device if the verification circuit has verified that the blockchain block includes a transaction with the predetermined property which is addressed to the blockchain address.

According to further embodiments, a method for controlling a function of an electronic device according to the electronic device described above is provided.

### BRIEF DESCRIPTION OF THE FIGURES

In the drawings, like reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows a consumable arrangement, consisting of a consumable and a consuming (or using) device.

FIG. 2 shows a block diagram of a blockchain network. i.e, a computer network for managing and operating a blockchain.

FIG. 3 shows a flow diagram illustrating a recycling process.

FIG. 4 shows a message flow diagram illustrating the blockchain-related part of the recycling process of FIG. 3.

FIG. 5 illustrates the verification of a transaction using a Merkle tree of a blockchain block.

FIG. 6 shows an electronic device according to an embodiment.

FIG. 7 shows a flow diagram illustrating a method for controlling a function of an electronic device according to an embodiment.

### DETAILED DESCRIPTION

The following detailed description refers to the accompanying drawings that show, by way of illustration, specific details and aspects of this disclosure in which the invention may be practiced. Other aspects may be utilized and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

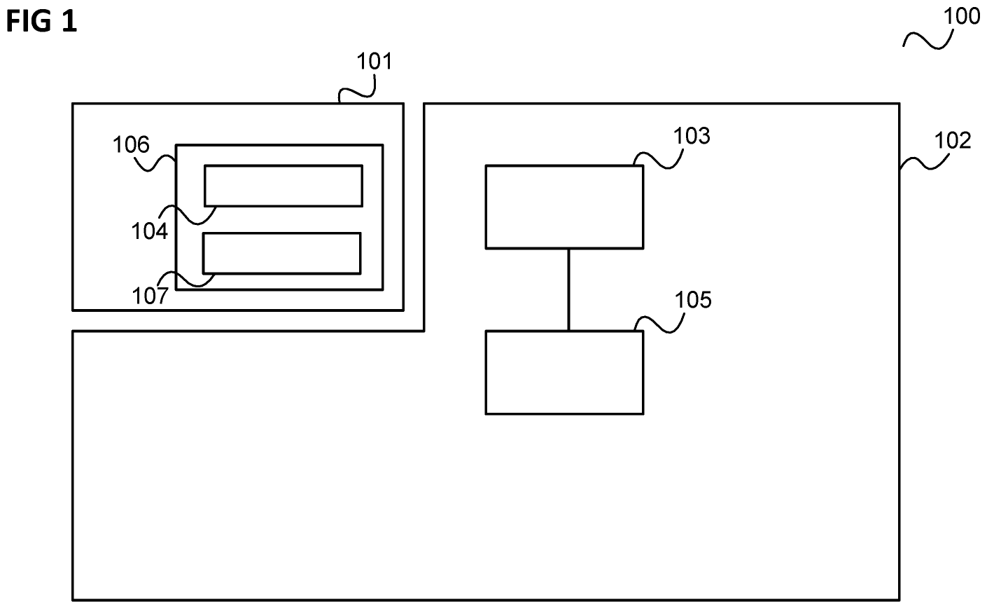

FIG. 1 shows a consumable arrangement 100, consisting of a consumable 101 and a consuming (or using) device 102.

The consumable 101 is a device that provides (and, for example, stores) a resource that is consumed when the consuming device 102 is operated. Examples of pairs of consumable 101 and consuming device 102 are
printer Cartridge—printer
battery—electrical device powered by the battery
refill cartridge—e-cigarette
credit card—prepaid mobile phone
coffee capsule—coffee machine
water filter cartridge—water filter.

For example, the consumable include a (physical) material that is consumed, such as a printer cartridge, certain types of batteries or an e-cigarette refill cartridge or even a medical substance (e.g. medicine) for a medical device in a corresponding container. In another form, however, the consumable may also include a non-physical resource that is consumed, such as a credit, for example, for a prepaid mobile phone.

For example, the consumable 101 is physically connected to the consuming device 102, for example, plugged in or installed. The consumable 101 is typically connected to the consuming device 102 in an exchangeable (especially detachable) manner.

The manufacturer of a consuming device 102 typically wishes that only consumables 101 manufactured by himself (or a licensee) can be used with the consuming device 102.

Therefore, the consuming device 102 may be provided with a host-side authentication circuit 103 to which a consumable-side authentication circuit 104 needs to authenticate itself. For example, the consuming device 102 comprises a controller 105 which permits operation of the consuming device 102 (also referred to as host) with the consumable 101 (also referred to as consumable) only when the consumable 101 has successfully authenticated itself to the host-side authentication circuit 103 of the consuming device 102 by means of a consumable-side authentication circuit 104. The consumable-side authentication circuit 104 may be part of an embedded system 106 (e.g. implemented in form of a chip) provided on or in the consumable 104.

It may be desired or required (e.g. by law) that a manufacturer of an original consuming device 102 and original consumables 101 allows a third party to recycle the original consumables, for example to refill empty printer cartridges. To allow the recycling of a consumable it is usually necessary to reset internal counters that track the usage of the consumable. While it is possible that no fee for recycling is paid (and a manufacturer simply releases a recycling password to recyclers to comply with legal obligations) this may not be desirable for the manufacturer.

In general, there may be use cases where a manufacturer (of an original consuming device 102 and original consumables 101) wants to establish a business model where a customer (third party) pays a fee and can then use extended functionality of an embedded system 106 (e.g. of a software running on the embedded system), or more generally extended functionality (i.e. one or more additional functions) of the consumable 101. In the recycling scenario, this extended functionality would be the functionality to allow recycling, e.g. refilling of the consumable. The embedded system 106 may for example have control over components of the consumable that allow preventing or enabling recycling (e.g. a valve or stop-cock for refilling or a counter which needs to be reset after the consumable 101 has been used up to allow again authentication of the consumable 101 at the consuming device 102). Thus, the embedded system 106 may implement both an authentication circuit 104 (which controls whether consumable 101 is used by the consuming device 102) but also a recycling authentication circuit 107 (which controls whether the consumable 101 may be recycled).

One approach to address such use cases is that the customer relies on license management and a payment transaction verification system of the manufacturer. However, if the manufacturer goes out of business it may become impossible for the customer to use the extended functionality (i.e. features in addition to normal usage with the consuming device 102 such as refilling).

Therefore, according to various embodiments, the above use cases are addressed such that an embedded device 106 of a consumable can verify that a transaction for a license fee or payment was made in a lightweight manner. Moreover, according to various embodiments, this verification is possible without the need that the embedded device 106 has an online connection to a central server or trusted authority (e.g. the manufacturer who may go out of business).

According to various embodiments, an approach is provided in which a digital currency running on a blockchain enables license management or the activation of extended functionality of a consumable 101 (e.g. of the embedded system 106). The manufacturer of a consumable 101 can obtain the digital currency from the blockchain while the consumable 101 (e.g. the embedded system 106) verifies that a payment has been made. In case the verification has been successful, the consumable can e.g., enable certain functions, e.g. enable refilling.

It should be noted that this approach is not limited to consumables but may also be used for the activation of functions (or features) in other (e.g. embedded) devices, e.g. for making certain library functions or more memory available. One example is that the device is a car and the functions to be enabled are specific motor functions (e.g. for “more horse power over the weekend”). Another example is a smart card that includes another digital currency or tokens, e.g., for access. The described mechanism could be used to add value to the digital currency on the card or to enable a token. Another example would be an embedded secure element, for which the described mechanism is used to renew a license code.

For the following example, the use-case of recycling is used and the blockchain is the bitcoin blockchain provided by the bitcoin network. Instantiations with other blockchains (e.g. ethereum) or other use-cases (e.g. license management) are possible. It should be noted that typically, internal monotonic counters of an authentication device (e.g. consumable-side authentication circuit 104) that cannot (normally) be reset prevent a refill or recycling of a consumable. The approaches described herein allow the recycling or refill of a consumable where the refilling is only allowed if the recycling entity sends a certain amount of digital currency to the original manufacturer and where an authentication device (e.g. embedded system 106) verifies this transfer using blockchain technology. This allows a compromise where recycling is possible for environmental reasons but where the business model of the original manufacturer is not threatened and where no third parties (further to the recycler) are involved.

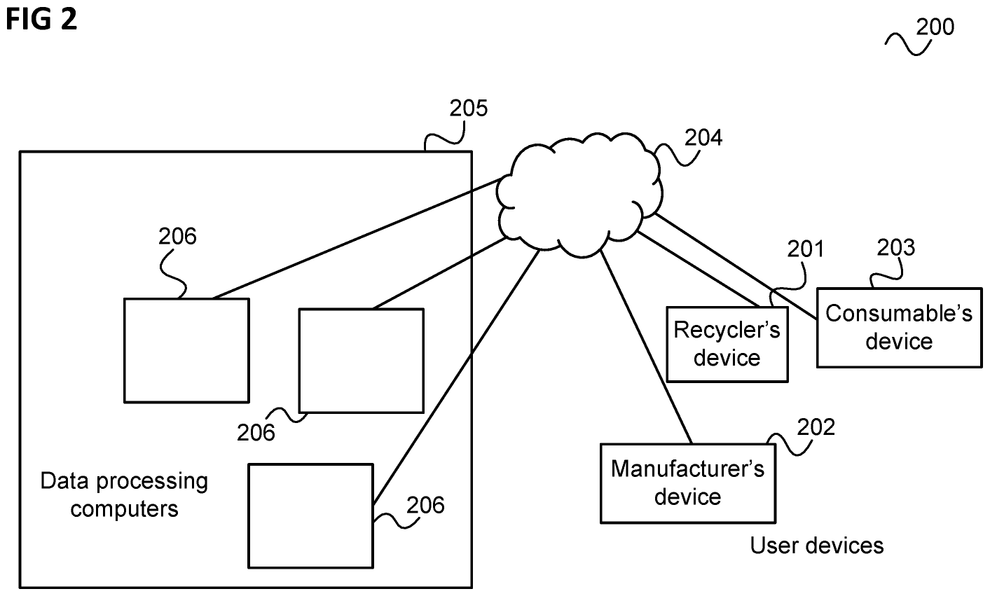

FIG. 2 shows a block diagram of a blockchain network 200, i.e. a computer network for managing and operating a blockchain.

The blockchain network 200 may include one or more user devices 201 to 203 and a blockchain provider computer arrangement 205 including one or more data processing computers 206. Each of these devices and computers may be communicatively coupled with each other via a communication network 204 such as the Internet using a suitable communication protocol.

The blockchain provider computer arrangement 205 (which can also be seen as blockchain provider) provides the blockchain functionality. The blockchain provider computer arrangement 205 can include a single device or multiple devices configured to maintain aspects of the blockchain such as creation of blockchain blocks.

In the blockchain network 200, data transfer request messages may be exchanged. A data transfer request message may be understood as an electronic message utilized to request a data transfer. A data transfer request message may be initiated by a user device 201 (e.g., a user device operated by a user). A data transfer request message may also be initiated. by a data processing computer 206. The data transfer request message may indicate a recipient of the data transfer. The data transfer request message may indicate a value associated with the data transfer, i.e. a transaction value. By way of example, the value may indicate a monetary amount, a digital asset amount, e.g. an amount of tokens, a number of points (e.g., reward points, a score, etc.), or any suitable value of transferable data. So, for example a first user device 201 may initiate a transaction of a digital currency to a second user device 202.

In the present example use case, the first user device 201 is the user device of a recycler who intends to refill a consumable 101 and therefore needs to make a transaction to the manufacturer of the consumable 101. The second user device 202 is for example a device of the manufacturer (which allows the manufacturer to use currency transferred to him by a transaction by in turn initiating further transactions).

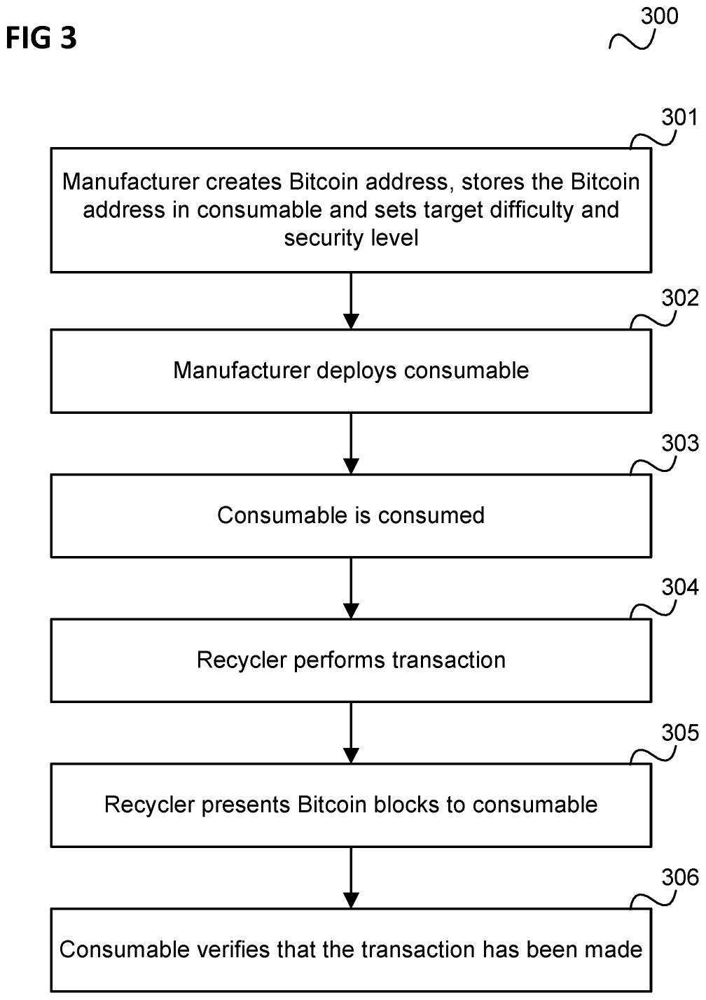

FIG. 3 shows a flow diagram 300 illustrating a recycling process.

In 301, to enable recycling, the manufacturer creates a blockchain address (i.e., a public/private key pair) for use in the blockchain (e.g. to have a target address (which is given by the public key) for a digital currency (e.g., bitcoin)). When an amount of digital currency is transferred to the public key by a transaction, the manufacturer may use the private key to access the amount of digital currency (i.e. perform a further transaction of the digital currency). He can do that independently from the device (i.e. of the consumable 101 and recycling authentication circuit 107).

The manufacturer puts the blockchain address (i.e., public key or a hash of the public key) into a memory of the recycling authentication circuit 107 attached to the consumable 101 and configures the recycling authentication circuit 107 to require a certain amount of digital currency m to allow recycling. The recycling authentication circuit 107 may correspond to a third user device 203 which however, as described below, does not initiate transactions itself and is not the target of transactions but verifies whether a transaction has been made to the second user device 202 (i.e. to the manufacturer) to enable additional functionality (recycling in the present use case). It should be noted that it is not necessary that this third user device 203 is permanently connected to the blockchain providing arrangement 205 but it is sufficient that it is provided with information based on which it can verify that a transaction to the manufacturer has been made.

Moreover, the manufacturer sets a target difficulty dill and security level lev. This difficulty should be such that the blockchain network's difficulty (e.g. bitcoin difficulty) will with high probability not be lower than cliff.

In 302, the consumable 101 with the recycling authentication circuit 107 is deployed in the field and its contents (e.g. ink) are used up in 303.

The recycler now performs the following to be able to have the recycling authentication circuit 107 allow recycling (e.g. to reset a counter of the recycling authentication circuit 107).

In 304, the recycler obtains the published address addr (i.e., public key or hash) from the memory of the recycling authentication circuit 107 and creates a transaction (with the recycler's first user device 101) where the amount of m is sent to this address addr to pay the amount m to the published address addr. The transaction gets put into the blockchain into block Y.

In 305, the recycler then waits lev additional blocks after the block Y is put in the blockchain and presents the Y to Y+lev blocks to the recycling authentication circuit 107 (thus lev+1 blocks overall). This may be done in a resource efficient manner that allows efficient parsing and validation of the data structures even on a device (e.g. embedded system) with small memory.

In 306, the recycling authentication circuit 107 verifies that the transaction in the block is actually sending the required amount m to the address addr. For that the recycling authentication circuit 107 verifies that headers of the following blocks are valid and follows the expected proof of work mechanism. In this case the authentication device enables recycling (e.g. by resetting an internal counter). In detail, the recycling authentication circuit 107 verifies that the blocks presented by the recycler are a valid part of a blockchain, that the difficulty has been above diff for all blocks and that the first block includes a payment of amount m to addr. If all this can be successfully verified, the recycling authentication circuit 107 enables itself to be ready to recycle, i.e. allows recycling (e.g. refilling).

It should be noted that according to one embodiment, the recycling authentication circuit 107 does not verify whether the presented blocks (in particular the first block including the transaction) belong to the public blockchain.

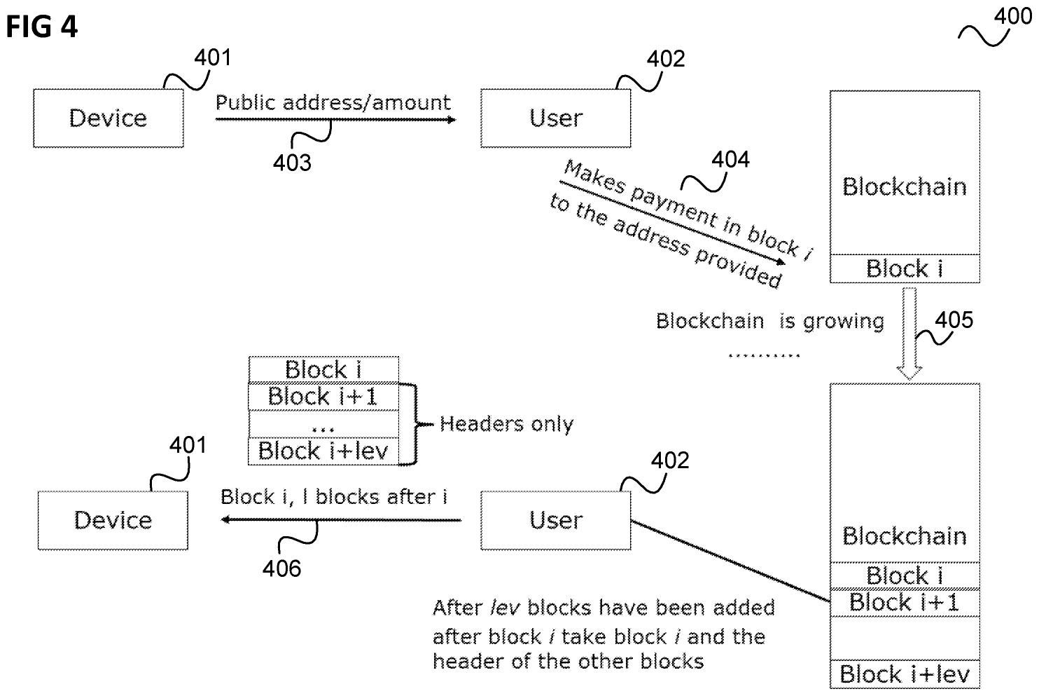

FIG. 4 shows a message flow diagram 400 illustrating the blockchain-related part of the recycling process of FIG. 3.

A consumable 401 and a recycler 402 are involved in the flow.

In 403, the consumable 401 provides the recycler 402 with the address addr and the amount m. For example, the recycler 402 may read out this information from the consumable's memory. In 404, the recycler 402 makes a payment to the address addr of the amount m by putting a corresponding transaction on the blockchain (assumed to be in block with the number i).

In 405, the blockchain is growing and when the blockchain has grown to block i+lev, in 406, the recycler takes block i and the header of blocks i+1 to i+lev and provides this information to the consumable 401 for verification.

With regard to security, it should be noted that behind every (possibly fake) payment there is the computational power of lev+1 blocks. If the payment is legit, this computation is carried out with high probability by the bitcoin network or another blockchain. The manufacturer chooses lev such that faking a payment, i.e. computing lev+1 blocks is more expensive than m.

The security can thus be ensured because if the value lev is chosen to be high enough (e.g. 100) it is very expensive for an attacker to create a fake chain with difficulty dill The attacker would have to create 100 blocks solely for faking a single transaction. For the public blockchain the other miners will create the next blocks “for free” (from the point of view of the attacker) while the attacker has to put in a large amount of work for creating fake blocks. The attacker could therefore instead spend the effort on the public blockchain and obtain higher rewards (e.g. mined currency or the right to do a certain amount of transactions without having to pay transaction fees). Even if an attacker intends to create a fake side chain that is only used for recycling (i.e. all transactions in the fake sidechain are transactions that enable recycling) this may be countered by a sufficient value for lev and cliff.

As mentioned above, the verification of 306 may be implemented to allow an efficient verification (of the transaction and the presented blocks) with low memory requirements to allow performing the verification on an embedded system 106 with little memory. It should be noted that blocks in bitcoin can be 1 MB large. Thus, an embedded device 106 with little memory may not be able to process the transaction by reading in the whole block and the following lev blocks.

However, it should be noted that typically, most nodes (thin nodes) of a blockchain network do not store all transactions in a block but rather the block header, including the Merkle tree root. When a node (e.g. user devise 203) wants to verify whether a specific transaction is legit, a node storing full blocks (full node) may provide a Merkle path. Given a block, a transaction t, and a Merkle path, a node may check whether the t is in the block. Thus, storage and bandwidth requirements may be reduced (compared to verification using full blocks).

Thus, in the use case above, the recycler only has to provide a specification of the transaction and a working Merkle tree traversal to the consumable as well as the block headers for the next blocks. They can be processed by the consumable online where checksums are generated on the data and where the data (e.g., headers) are then discarded.

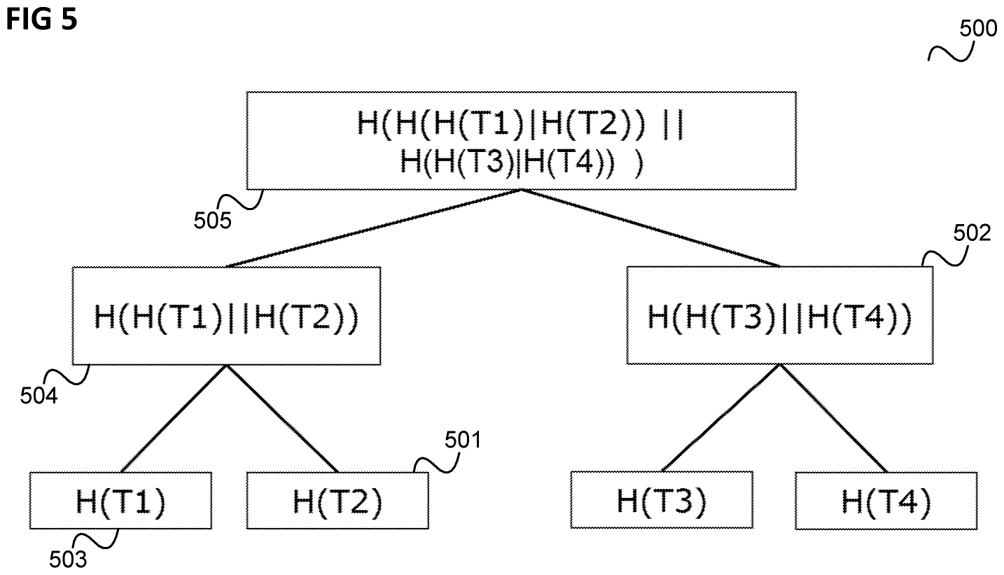

FIG. 5 illustrates the verification of a transaction using a Merkle tree 500 of a blockchain block.

If a node (e.g. recycling authorization circuit 107 of consumable 101) wants to verify that transaction T1 is in the blockchain block, it is provided with the hashes 501, 502 by a full node (e.g. by the user device 202 of the recycler). The node then calculates the hash 503 of T1 and, with the help of the provided hashes 501, 502 successively the hashes 504 and 505. It may then compare the root hash 505 with the root hash of the blockchain block to verify the transaction is included in the block.

It should be noted that a recycler may be allowed to recycle several consumables with a single transaction (e.g. by providing multiple consumables with the same bitcoin address). This may be desirable in case the transaction fee is too high to justify the transaction cost for recycling a single consumable.

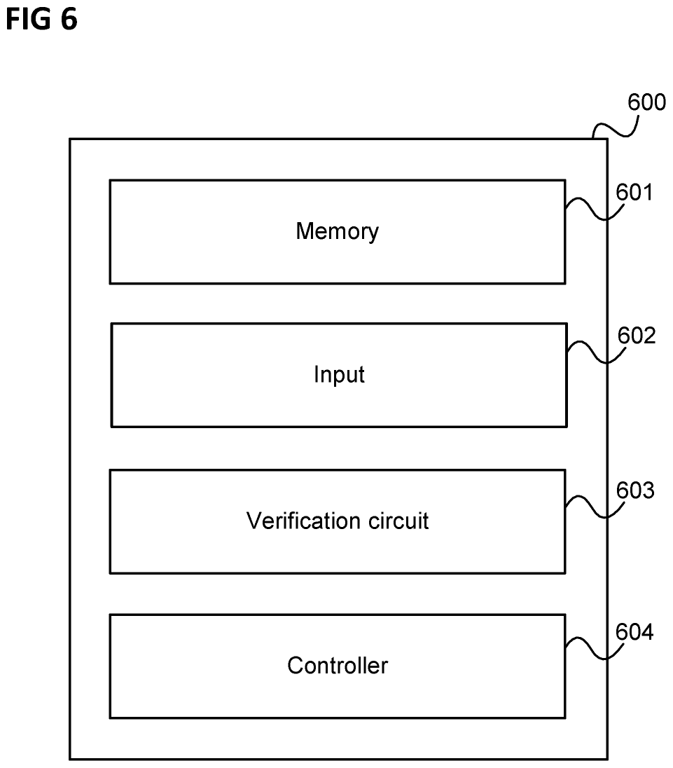

In summary, according to various embodiments, an electronic device is provided as illustrated in FIG. 6.

FIG. 6 shows an electronic device 600 according to an embodiment.

The electronic device 600 includes a memory 601 (e.g. a non-volatile memory such as a flash memory) configured to store a cryptographic blockchain address (which is for example a device-specific address (specific for the electronic device 600).

Further, the electronic device 600 includes an input 602 (e.g. a wired or wireless interface) configured to receive at least parts of a blockchain block.

The electronic device 600 includes a verification circuit 603 configured to verify whether the blockchain block includes a transaction (e.g. includes the transaction, described the transaction or includes a specification of the transaction) with a predetermined property which is addressed to the blockchain address and a controller 604 configured to enable a function of the electronic device 600 if the verification circuit 603 has verified that the blockchain block includes a transaction with the predetermined property which is addressed to the blockchain address.

According to one embodiment, in other words, an electronic device receives at least parts of a blockchain block, namely parts which allow verifying whether the blockchain block includes a transaction with a predetermined property (e.g. that it transfers a sufficient amount) which is addressed to a blockchain address associated with the electronic device (by storing it in the electronic device). The electronic device may then verify that a transaction has been made to the blockchain address (e.g. of a certain predetermined amount) and if this is the case, i.e. if it can be successfully verified that such a transaction has been made, the electronic device enables a certain functionality. The electronic device may include circuitry (e.g. a microcontroller, for example implemented by a chip) which performs the corresponding operations, e.g. implements the verification circuit and the controller. The predetermined property (e.g. a minimum amount of cryptocurrency that has to be transferred) may be predefined in the electronic device and may for example be unchangeable after deployment of the electronic device.

The electronic device may be a control device of a larger device (e.g. a controlled device such as a vehicle) and the functionality may correspond to a functionality of the larger device (e.g. a vehicle controller may enable the functionality that the vehicle may be driven at higher speed). According to various embodiments, the electronic device is a controller (e.g. an authentication chip) of a consumable and the functionality is that the electronic device allows recycling (e.g. refilling) of the consumable. The input may for example be formed by an interface between the consumable and the consuming device, e.g. an interface based on a connection formed by a contact between terminals of the electronic device and the consuming device when the consumable is inserted in the consuming device.

The blockchain address is for example a public key of a key pair of an asymmetric cryptographic scheme. A transaction being addressed to the blockchain address may be understood as the transaction being addressed to an address derived from the public key (e.g. a hash of the public key). The holder of the corresponding private key (i.e. the private key of the key pair to which the public key belongs) may access the amount which is transferred to the public key by the transaction (e.g. may initiate one or more further transactions of the amount, e.g. cryptocurrency, which is transferred to the public key by the transaction). This means that in the recycling use case above, the manufacturer may hold the private key and may collect a recycling fee that the recycler transfers to the public key.

A user that intends to use the functionality (e.g. the recycler in the recycling use case) may be the one that transfers the parts of the blockchain block (and possible parts of subsequent blocks for enhancing security) to the electronic device. The parts of the blockchain block may include a data element of the blockchain block specifying the transaction. A user may thus make use of a chip (e.g. attached to a consumable for authentication at a consuming device) for enabling recycling. This may be applied in particular in use cases where consumable should not be shared between consuming devices (e.g., for safety reasons).

The verification circuit may be configured to verify that the blockchain blocks (and possibly of one or more subsequent blocks) are valid. This may include verifying the proof of work (or, depending on the blockchain protocol used the proof of stake) of the blockchain blocks. A corresponding threshold for the proof of work (or stake) may be defined and stored in the memory 601. This threshold can be seen to specify a certain minimum difficulty (diff in the above examples).

Thus, according to various embodiments, an efficient verification (e.g. by use of the Merkle tree) of a chain of blocks obtained from a public blockchain that include a transaction is used to enable a special feature of an embedded device, thus removing the need of a trusted third party.

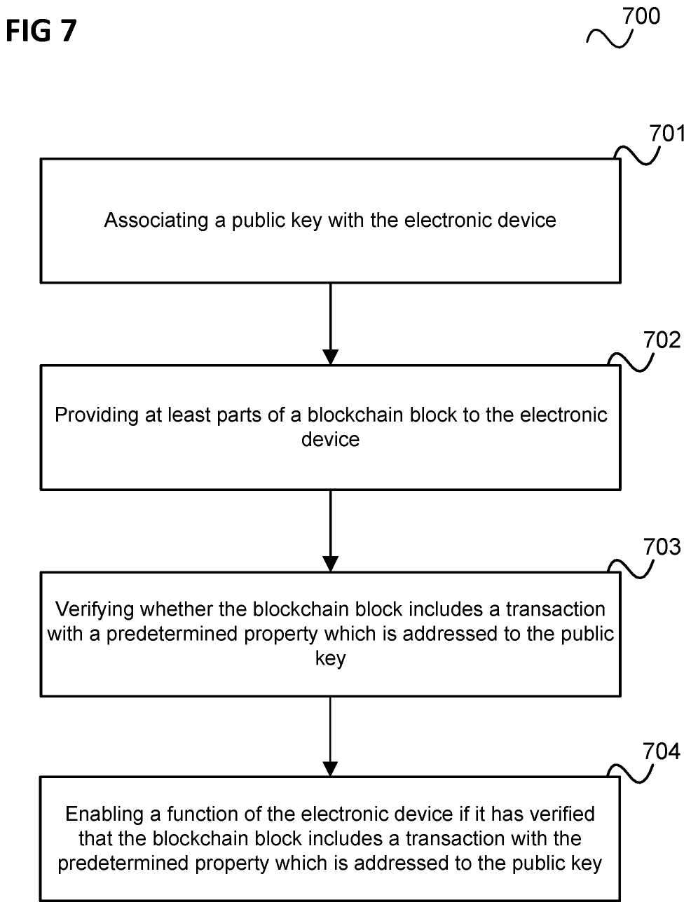

According to various embodiments, a method is provided as illustrated in FIG. 7.

FIG. 7 shows a flow diagram 700 illustrating a method for controlling a function of an electronic device according to an embodiment.

In 701, a blockchain address is associated with the electronic device.

In 702, at least parts of a blockchain block are provided to the electronic device.

In 703, the electronic device verifies whether the blockchain block includes a transaction with a predetermined property which is addressed to the blockchain address.

In 704, the electronic device enables a function of the electronic device if it has verified that the blockchain block includes a transaction with the predetermined property which is addressed to the blockchain address.

Various Examples are described in the following:

Example 1 is an electronic device as illustrated in FIG. 6.

Example 2 is the electronic device of Example 1, wherein the blockchain address is a cryptographic public key or a hash of a cryptographic public key.

Example 3 is the electronic device of Example 1 or 2, wherein the blockchain block is a block of a blockchain of a cryptocurrency and the predetermined property is that the transaction transfers a predetermined amount of cryptocurrency.

Example 4 is the electronic device of any one of Examples 1 to 3, wherein the input is further configured to receive at least parts of one or more subsequent blockchain blocks subsequent to the blockchain block and the verification circuit is configured to verify whether the blockchain block includes a transaction with the predetermined property which is addressed to the blockchain address based on the one or more subsequent blockchain blocks.

Example 5 is the electronic device of Example 4, wherein the input is further configured to receive at least parts of the one or more subsequent blockchain blocks and the verification circuit is configured to verify whether the blockchain block includes a transaction with the predetermined property which is addressed to the blockchain address and the one or more subsequent blockchain blocks are valid and the controller is configured to enable the function of the electronic device if the verification circuit has verified that the blockchain block includes a transaction with the predetermined property which is addressed to the blockchain address and that the one or more subsequent blockchain blocks are valid.

Example 6 is the electronic device of Example 5, wherein the memory is configured to store a target difficulty and is configured to verify whether the one or more subsequent blockchain blocks are valid by verifying that the one or more subsequent blockchain blocks are part of a blockchain with a difficulty being at least the target difficulty.

Example 7 is the electronic device of Example 5 or 6, wherein the verification circuit is configured to verify whether the one or more subsequent blockchain blocks are valid based on the block headers or block hashes of the one or more subsequent blockchain blocks.

Example 8 is the electronic device of any one of Examples 5 to 7, wherein the input is configured to receive the block headers or block hashes of the one or more subsequent blockchain blocks.

Example 9 is the electronic device of any one of Examples 5 to 8, wherein the memory is configured to store a target security level and the controller is configured to enable the function of the electronic device if the verification circuit has verified that the blockchain block includes a transaction with the predetermined property which is addressed to the blockchain address and that the one or more subsequent blockchain blocks includes a number of subsequent blockchain blocks equal or higher than the security level and the subsequent blockchain blocks are valid.

Example 10 is the electronic device of any one of Examples 1 to 9, wherein the input is configured to receive a root hash of the blockchain block and the verification circuit is configured to verify whether the blockchain block includes a transaction which is addressed to the blockchain address based on the root hash.

Example 11 is the electronic device of Example 10, wherein the input is further configured to receive hashes allowing verifying whether a Merkle tree of the blockchain includes a hash of the transaction which is addressed to the blockchain address and the verification circuit is configured to verify whether the blockchain block includes a transaction which is addressed to the blockchain address using the received hashes and the root hash.

Example 12 is the electronic device of any one of Examples 1 to 11, wherein the electronic device is a controlling device of a controlled device and the function is a function for controlling the controlled device in a predetermined manner.

Example 13 is the electronic device of any one of Examples 1 to 12, wherein the electronic device is a controller of a consumable and the function is the enablement of recycling of the consumable.

Example 14 is the electronic device of Example 13, wherein the input is an interface to a consuming device.

Example 15 is the electronic device of any one of Examples 1 to 14, wherein the electronic device is an offline device.

Example 16 is the electronic device of any one of Examples 1 to 15, wherein the electronic device is free of communication network functionality.

Example 17 is a method as illustrated in FIG. 7.

Example 18 is the method of Example 17, wherein the blockchain address is a cryptographic public key or a hash of a cryptographic public key.

Example 19 is the method of Example 17 or 18, wherein the blockchain block is a block of a blockchain of a cryptocurrency and the predetermined property is that the transaction transfers a predetermined amount of cryptocurrency.

Example 20 is the method of any one of Examples 17 to 19, including receiving at least parts of one or more subsequent blockchain blocks subsequent to the blockchain block and verifying whether the blockchain block includes a transaction with the predetermined property which is addressed to the blockchain address based on the one or more subsequent blockchain blocks.

Example 21 is the method of Example 20, including receiving at least parts of the one or more subsequent blockchain blocks, verifying whether the blockchain block includes a transaction with the predetermined property which is addressed to the blockchain address and the one or more subsequent blockchain blocks are valid and enabling the function of the electronic device if it has been verified that the blockchain block includes a transaction with the predetermined property which is addressed to the blockchain address and that the one or more subsequent blockchain blocks are valid.

Example 22 is the method of Example 21, including storing a target difficulty and verifying whether the one or more subsequent blockchain blocks are valid by verifying that the one or more subsequent blockchain blocks are part of a blockchain with a difficulty being at least the target difficulty.

Example 23 is the method of Example 21 or 22, including verifying whether the one or more subsequent blockchain blocks are valid based on the block headers or block hashes of the one or more subsequent blockchain blocks.

Example 24 is the method of any one of Examples 21 to 23, including receiving the block headers or block hashes of the one or more subsequent blockchain blocks.

Example 25 is the method of any one of Examples 21 to 24, including storing a target security level and enabling the function of the electronic device if it has been verified that the blockchain block includes a transaction with the predetermined property which is addressed to the blockchain address and that the one or more subsequent blockchain blocks includes a number of subsequent blockchain blocks equal or higher than the security level and the subsequent blockchain blocks are valid.

Example 26 is the method of any one of Examples 17 to 25, including receiving a root hash of the blockchain block and verifying whether the blockchain block includes a transaction which is addressed to the blockchain address based on the root hash.

Example 27 is the method of Example 26, including receiving hashes allowing verifying whether a Merkle tree of the blockchain includes a hash of the transaction which is addressed to the blockchain address and verifying whether the blockchain block includes a transaction which is addressed to the blockchain address using the received hashes and the root hash.

Example 28 is the method of any one of Examples 17 to 27, wherein the electronic device is a controlling device of a controlled device and the function is a function for controlling the controlled device in a predetermined manner.

Example 29 is the method of any one of Examples 17 to 28, wherein the electronic device is a controller of a consumable and the function is the enablement of recycling of the consumable.

Example 30 is the method of Example 29, wherein the at least parts of the blockchain block are received via an interface to a consuming device.

Example 31 is the method of any one of Examples 17 to 30, wherein the electronic device is an offline device.

Example 32 is the method of any one of Examples 17 to 31, wherein the electronic device is free of communication network functionality.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

### REFERENCE SIGNS

100 consumable arrangement

101 consumable

102 consuming device

103 host-side authentication circuit

104 consumable-side authentication circuit

105 controller

106 embedded system

107 recycling authentication circuit

200 blockchain network

201-203 user devices

205 blockchain provider computer arrangement

206 processing computers

204 communication network

300 flow diagram

301-306 processing

400 message flow diagram

401 consumable

402 recycler

403-406 processing

500 Merkle tree

501-505 hashes

600 electronic device

601 memory

602 input

603 verification circuit

604 controller

700 flow diagram

701-704 processing

What is claimed is:

1. An electronic device comprising:
A memory configured to store a cryptographic blockchain address;
An input configured to receive at least parts of a blockchain block;
A verification circuit configured to verify whether the blockchain block includes a transaction with a predetermined property which is addressed to the blockchain address; and
A controller configured to enable a function of the electronic device if the verification circuit has verified that the blockchain block includes a transaction with the predetermined property which is addressed to the blockchain address.

2. The electronic device of claim 1, wherein the blockchain address is a cryptographic public key or a hash of a cryptographic public key.

3. The electronic device of claim 1, wherein the blockchain block is a block of a blockchain of a cryptocurrency and the predetermined property is that the transaction transfers a predetermined amount of cryptocurrency.

4. The electronic device of claim 1, wherein the input is further configured to receive at least parts of one or more subsequent blockchain blocks subsequent to the blockchain block and the verification circuit is configured to verify whether the blockchain block includes a transaction with the predetermined property which is addressed to the blockchain address based on the one or more subsequent blockchain blocks.

5. The electronic device of claim 4, wherein the input is further configured to receive at least parts of the one or more subsequent blockchain blocks and the verification circuit is configured to verify whether the blockchain block includes a transaction with the predetermined property which is addressed to the blockchain address and the one or more subsequent blockchain blocks are valid and the controller is configured to enable the function of the electronic device if the verification circuit has verified that the blockchain block includes a transaction with the predetermined property which is addressed to the blockchain address and that the one or more subsequent blockchain blocks are valid.

6. The electronic device of claim 5, wherein the memory is configured to store a target difficulty and is configured to verify whether the one or more subsequent blockchain blocks are valid by verifying that the one or more subsequent blockchain blocks are part of a blockchain with a difficulty being at least the target difficulty.

7. The electronic device of claim 5, wherein the verification circuit is configured to verify whether the one or more subsequent blockchain blocks are valid based on the block headers or block hashes of the one or more subsequent blockchain blocks.

8. The electronic device of claim 5, wherein the input is configured to receive the block headers or block hashes of the one or more subsequent blockchain blocks.

9. The electronic device of claim 5, wherein the memory is configured to store a target security level and the controller is configured to enable the function of the electronic device if the verification circuit has verified that the blockchain block includes a transaction with the predetermined property which is addressed to the blockchain address and that the one or more subsequent blockchain blocks includes a number of subsequent blockchain blocks equal or higher than the security level and the subsequent blockchain blocks are valid.

10. The electronic device of claim 1, wherein the input is configured to receive a root hash of the blockchain block and the verification circuit is configured to verify whether the blockchain block includes a transaction which is addressed to the blockchain address based on the root hash.

11. The electronic device of claim 10, wherein the input is further configured to receive hashes allowing verifying whether a Merkle tree of the blockchain includes a hash of the transaction which is addressed to the blockchain address and the verification circuit is configured to verify whether the blockchain block includes a transaction which is addressed to the blockchain address using the received hashes and the root hash.

12. The electronic device of claim 1, wherein the electronic device is a controlling device of a controlled device and the function is a function for controlling the controlled device in a predetermined manner.

13. The electronic device of claim 1, wherein the electronic device is a controller of a consumable and the function is the enablement of recycling of the consumable.

14. The electronic device of claim 13, wherein the input is an interface to a consuming device.

15. The electronic device of claim 1, wherein the electronic device is an offline device.

16. The electronic device of claim 1, wherein the electronic device is free of communication network functionality.

17. A method for controlling a function of an electronic device comprising:
associating a blockchain address with the electronic device;
providing at least parts of a blockchain block to the electronic device;
the electronic device verifying whether the blockchain block includes a transaction with a predetermined property which is addressed to the blockchain address; and
the electronic device enabling a function of the electronic device if it has verified that the blockchain block includes a transaction with the predetermined property which is addressed to the blockchain address.
